(19) United States
(12) Patent Application Publication
(10) Pub. No.: US 2002/0029179 A1
(43) Pub. Date: Mar. 7, 2002

(54) System and method for interactive fundraising over a wide-area network

(76) Inventors: Allen B. Gruber, San Antonio, TX (US); Harry E. Gruber, Rancho Santa Fe, CA (US); Ephraim Feig, San Diego, CA (US); Dennis N. Berman, Rancho Santa Fe, CA (US)

Correspondence Address: KINTERA INC., 9605 SCRANTON ROAD, SUITE 240, SAN DIEGO, CA, 92121, US

(21) Appl. No.: 09/740,761

(22) Filed: Dec. 12, 2000

(51) Int. Cl. G06F 17/60

(52) U.S. Cl. 705/35

(57) ABSTRACT

A system and method for on-line, interactive fundraising over a wide-area network is provided. The method includes hosting an organization's website including a plurality of hyperlinked web pages, displaying one or more virtual plaque web pages honoring donors, providing one or more donation and payment option web pages, the options selectable by a donor, and modifying or otherwise updating virtual plaques on the virtual plaque web pages when a donation is made. The method further includes creating a personalized donation page for the donor. The method further includes e-mailing the virtual plaques or the links thereto to potential donors, thereby spreading the message regarding the cause and increasing the likelihood of contribution from additional donors. The method further includes editing and modifying the virtual plaque. The virtual plaque can be static or a scrolling plaque. The method additionally includes generating reports with information, such as total amount raised, number of donors, average amount of donations, deductions for tax purposes, etc,

### BACKGROUND

1. Field of Invention

The present invention relates generally to on-line fundraising. More specifically, the present invention relates to a system and method for interactive fundraising over a widearea computer network such as the Internet.

2. Description of Prior Art

Charitable and other non-profit organizations often raise money through fundraising. These organizations utilize various well-known methods to establish contact with potential donors that often lead a potential donor to make a contribution to the organizations. Common fundraising schemes include live events, mail campaigns, and telephone calls.

Unfortunately, these fundraising methods have some disadvantages. Live fundraising events on television and radio are often expensive to stage. Often, a small fraction of the money received through donations ultimately go to the intended charity as so much money is consumed in the process of simply staging the live event. Furthermore, other means are often required to supplement the live events. These include appeals via mail and the use of pre-recorded material on radio and television to educate potential donors about the charity and the fundraising event. High cost and uncertainty of return often make the staging of a live event a risky endeavor.

Another problem associated with live fundraising events relates to the charitable organization's inability to identify and follow up with potential donors after the conclusion of the live event. Most organizations have no mechanisms to identify and follow up with potential donors who may have attended but have chosen not to donate during the live event.

A further problem associated with live fundraising events is the inability of the organization to publicly acknowledge and honor donors for a long-term period after the conclusion of the live event. Donors are often motivated to contribute when they are publicly acknowledged and honored for a long-term period for their contribution. Live events typically acknowledge the donor during the event but have no means to acknowledge the donors for a long-term period.

The disadvantages associated with mail campaigns and telephone calls are also well known. Mail campaigns often fail to establish the personal contact necessary to motivate a potential donor to make a pledge. Mail campaigns typically have no mechanism to publicly honor donors for their contribution. Telephone calls often fail to establish the personal contact necessary to induce a donor to make a contribution. Often, telephone calls annoy recipients and are not very successful as a fundraising scheme.

In some cases, a pledge made during a live fundraising event is confirmed by an immediate financial transaction by providing credit card information over the phone. In other instances, a pledge is simply followed up by mail that solicits the payment of the pledged amount. In any event, the traditional method of pledge solicitation followed by mail requires a significant investment in ancillary communications efforts apart from the actual live event.

In recent years, financial transactions over the Internet or the World Wide Web have become common. The use of credit cards and other financial instruments on the Internet has become sufficiently secure so that there is less reluctance to engage in such transactions by the average consumer.

However, efforts to achieve on-line fundraising over the Internet have been met with mixed success. Many charitable and nonprofit organizations maintain websites that are designed to receive donations but do not provide a comprehensive scheme that will encourage potential donors to visit the site as well as to make contributions. Also, existing Internet-fundraising schemes either do not have the capability to instantly recognize a donor or they merely provide delayed recognition by publishing on-line a list of donors.

Accordingly, there is a need for an improved on-line interactive fundraising scheme that allows charitable organizations to promote their cause as well as to raise funds. There is a need for a system and method, which ultimately leads to improved contribution behavior by a potential donor and improved payment behavior by a pledgor. There is a further need for a system and method that allow charitable organizations to publicly acknowledge and honor donors for a longer term after the conclusion of the live event.

### SUMMARY OF THE INVENTION

It is an object of the present invention to provide an improved system and method for on-line fundraising over the Internet. It is a further object of the present invention to provide a system and method, which ultimately leads to improved contribution behavior by a potential donor and improved payment behavior by a pledgor.

In accordance with one embodiment of the present invention, an on-line fundraising system over a wide-area network for an organization comprises a website dedicated to the organization, including a plurality of hyperlinked web pages, one or more web pages with virtual plaques (also referred to as virtual plaque web pages), the virtual plaque web pages honoring one or more donors, one or more donation and payment option web pages, the options selectable by a donor, means for updating the web pages with the virtual plaques when a donation is made, and means for e-mailing the updated web pages with virtual plaques or the links to the plaques to potential donors, wherein the system allows a donor to spread the message regarding the charitable cause by forwarding the virtual plaques to other potential donors and thereby increasing the likelihood of contribution from additional donors. The recipients, in turn, may make a pledge, get an updated web page with a virtual plaque, and then forward the plaque to others.

In accordance with one embodiment of the present invention, a method for an online fundraising for an organization over a wide-area network comprises the steps of hosting the organization's website, including a plurality of hyperlinked web pages, displaying one or more virtual plaque web pages honoring donors, providing one or more donation and payment option web pages, the options selectable by a donor, and updating the virtual plaque web pages when a donation is made.

The method further comprises the step of e-mailing the updated virtual plaques or links thereof to potential donors. This allows the donor to spread the message regarding the fundraising and thereby increasing the likelihood of contribution from additional donors.

The method further comprises the step of providing promotional information about the organization and the cause associated with the fundraising on the website. The method further comprises the step of including information about the donor and the contribution on the web pages with the virtual plaques.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like parts, in which:

FIG. 1 is a block diagram of the present invention in association with a wide-area network;

FIG. 2 illustrates a block diagram of the overall system in accordance with one embodiment of the present invention;

FIGS. 3 and 4 are exemplary virtual plaques;

FIG. 5 is an exemplary web page giving various donation options;

FIG. 6 is an exemplary web page, which presents a viewer various payment options for paying a pledge;

FIG. 7 is an exemplary confirmation page;

FIG. 8 is a flow diagram illustrating an exemplary method for implementing interactive fundraising over the Internet.

FIG. 9 is an exemplary personalized donation page.

FIG. 10 is an exemplary e-mail acknowledging a donation.

### DETAILED DESCRIPTION OF THE INVENTION

Turning first to the nomenclature of the specification, the detailed description which follows is represented largely in terms of system block diagrams, processes and symbolic representations by conventional computer components, including a processor associated with a general-purpose computer system, memory storage devices for the processor, and connected display devices. These operations include the manipulation of data bits by the processor and the maintenance of these bits within data structures residing in one or more of the memory storage devices. Such structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

For the purpose of this discussion, a process or method is generally conceived to be a sequence of computer-executed steps leading to a desired result. These steps generally require manipulations of physical quantities. Usually, although not necessarily, these quantities take the form of electrical, magnetic, or optical signals capable of being stored, transferred, combined, compared or otherwise manipulated. It is conventional for those skilled in the art to refer to these signals as bits, values, elements, symbols, characters, terms, numbers, records, files or the like. It should be kept in mind, however, that these and some other terms should be associated with appropriate physical quantities for computer operations, and that these terms are merely conventional labels applied to physical quantities that exist within and during operation of the computer.

In addition, it should be understood that the systems and processes described herein are not related or limited to any particular computer, apparatus, or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hardwired logic or programs stored in non-volatile memory, such as read-only memory.

The present invention provides a solution to the problems associated with existing fundraising schemes. Briefly stated, the present invention is directed to an improved system and method for on-line fundraising over the Internet. The present invention provides a system and method, which ultimately leads to improved contribution behavior by a potential donor and improved payment behavior by a pledgor. In one embodiment, the invention allows charitable organizations to publicly acknowledge and honor donors for a prolonged time period during and after the conclusion of the fundraising campaign.

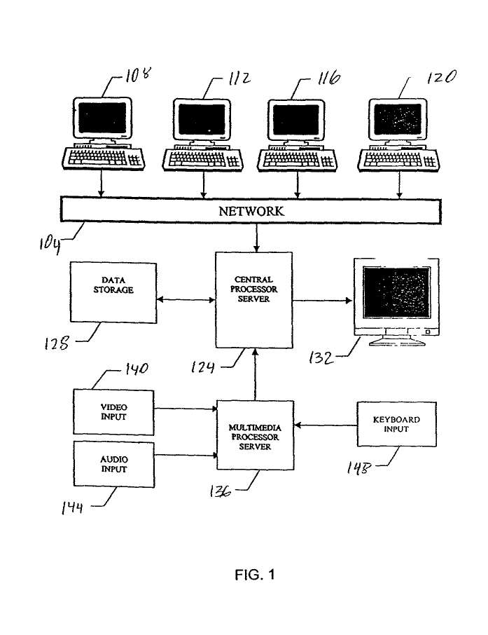

Referring now in more detail to the drawings, FIG. 1 is a block diagram of the present invention in association with a wide-area network. In FIG. 1, a wide-area network (e.g., the Internet) 104 is shown in conjunction with a number of representative user stations 108, 112, 116, and 120. It is well known in the art how to structure such wide-area network connections to provide two-way communication between various stations and locations connected to the network. In FIG. 1, a representative central processor server 124 is shown connected to the network 104 for two-way interactive communication between the central processor server 124 and the plurality of user stations. Also, as is well known in the art, many levels of communication can occur across network 104 as among individual stations and as between central processor servers and individual stations.

In one embodiment of the present invention, central processor server 124 would be a computer system established by the fundraising organization or its agent for the purpose of providing information to potential donors and for the purpose of soliciting contributions and perhaps also receiving pledges and donations. It is to be understood, however, that the central processor server 124 may also be a computer system operated by an organization specifically set up to carry out fundraising events and programs for a variety of charities and nonprofit organizations. The operation of the system and the methods involved are the same regardless of the nature of the organization that establishes and carries out the on-line functionality of the system.

The central process server 124 is linked to a data storage device 128 as well as to an appropriate display device 132. These mechanisms simply provide the means for storing information for presentation to the viewers, as well as the means for receiving information from viewers, either for immediate display or recording for later access.

Also associated with the central processor server 124 is a multimedia processor server 136. In some instances, the multimedia server 136 may simply comprise specific components contained within the central processor server 124 appropriate for receiving, digitizing, and transmitting multimedia data associated with an interactive event. In other instances, it would be preferable to have a separate hardware device carrying out the functions of the multimedia processor server and providing them to central processor server in the form of digital data configured and ready for broadcast over the network. In any event, the multimedia processor server 136 is structured to receive inputs from a video input 140, an audio input 144, and a keyboard input 148.

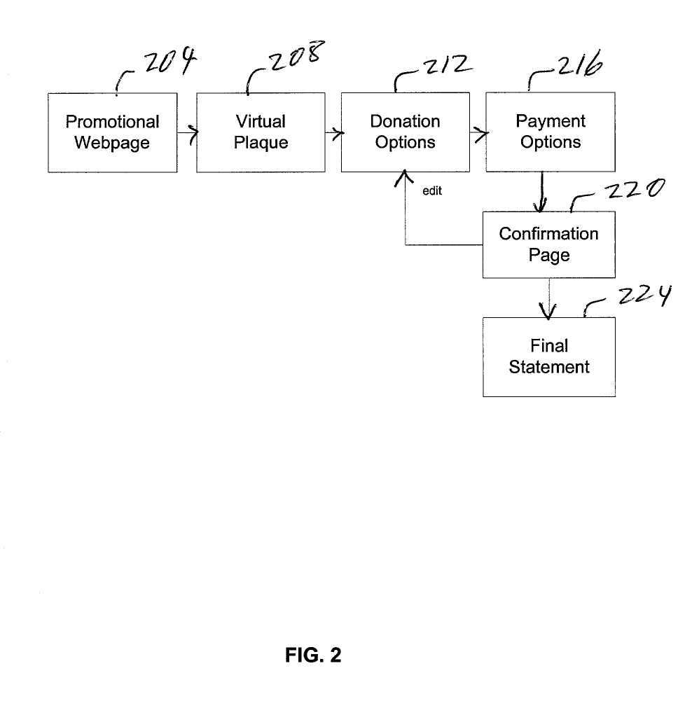

Reference is now made to FIG. 2 that illustrates a block diagram of the overall system in accordance with one embodiment of the present invention. FIG. 2 describes a framework within which a donor enters an organization's website, views one or more web pages with virtual plaques (also referred to as virtual plaque web pages), makes a donation, and views an updated web page with virtual plaques acknowledging and honoring the donor for a contribution. The organization can be a charitable organization, a nonprofit organization, a political action committee (PAC), a political campaign, or any other business entity.

A web page 204 in a charitable organization's website includes promotional information about the organization, including the charitable cause. The web page 204 is accessible on the Internet and published in an on-line format. Additionally, a charitable organization may employ other means for promoting its cause and in conjunction therewith advertise and promote use of its website.

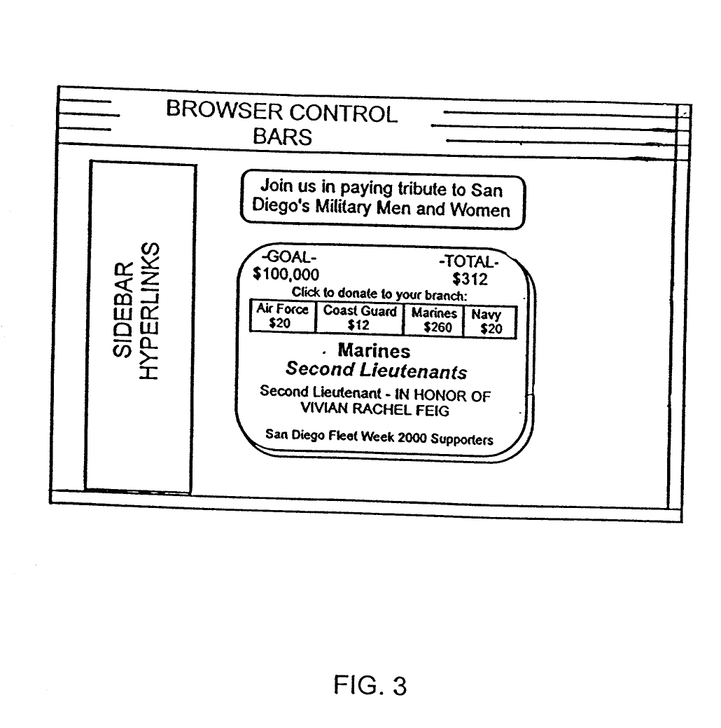

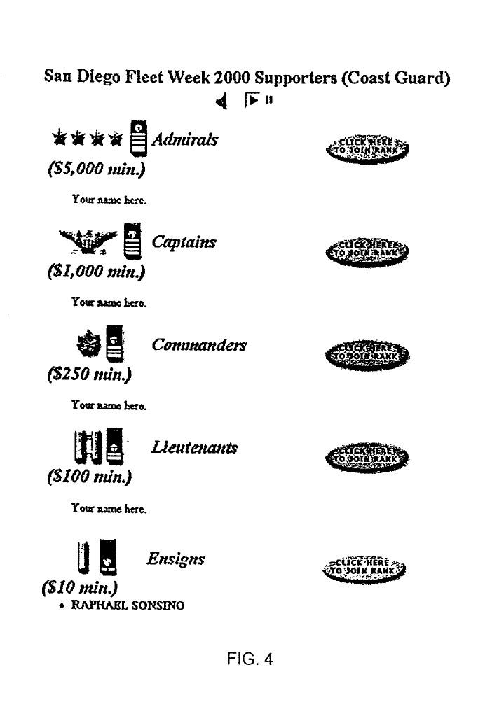

The web page 204 directs a viewer, preferably by hyperlink, to one or more other web pages 208, wherein the viewer sees a web page with one or more virtual plaques honoring those who have already pledged or given to the cause. A virtual plaque refers to a plaque that is created on a web page and which honors and acknowledges a donor. A virtual plaque may include the name of a single donor or the names of a plurality of donors on a web page. A web page may include a virtual plaque and an image of a book or an art work or any other object. In other words, a virtual plaque can be created on a web page containing the image of a book, an art work, or any other object. Examples of virtual plaques are shown in FIGS. 3 and 4. A virtual plaque may include solely the names of the donors or may include other information. Also, a virtual plaque may include an image of a piece of famous art or a book with the names of the donors imprinted thereon. A virtual plaque can be created in many other ways as will become apparent to those skilled in the art.

The virtual plaque can be static or it can be dynamically scrolled on the screen. The virtual plaque can be obtained by individuals or by corporations as well as by other entities. Thus, the virtual plaque can honor individuals as well as corporations and other entities. In one embodiment, a virtual plaque includes a link to other web pages.

In one embodiment, the virtual plaque web pages can be modified by the donor at the time of donation or later on. A donor may choose the specific words and language inscribed in the virtual plaque and is further able to modify the virtual plaque at a later time.

The virtual plaque can be created to honor and acknowledge a person, a cause or an object. For example, a virtual plaque can state “In Memory of John Doe” or “In Honor of John Doe.” A virtual plaque can be created to honor one or more anonymous donors.

A virtual plaque can be created with a digitized image of a famous piece of art or a book with a donor's name inscribed thereon. For example, a donor may donate for the benefit of a museum or a library. In that case, a virtual plaque can be created with a digitized image of a famous work of art or a book and the donor's name and other information inscribed thereon. A virtual plaque can also acknowledge and commemorate various causes, such as finding a cure for a disease or protecting the environment. Thus, an individual who donates to the Wildlife Foundation may obtain a virtual plaque with the foundation's official logo and his name inscribed thereon.

There can be various categories of virtual plaques depending on the amount of donation. For example, the size and design of the virtual plaque can be varied depending on the amount of donation. Also, the placement and location of the donor's name and the prominence of the manner of placement on the virtual plaque can be varied depending on the amount of donation.

In one embodiment, a virtual plaque can be shown on the television screen. For example, if a fundraising campaign is conducted on television, a virtual plaque can be created and broadcasted on television. For example, a scrolling virtual plaque can be shown on a television screen. In those instances where a fundraising campaign is conducted on television and on the Internet, a virtual plaque can be viewed both on a television and a computer screen.

The virtual plaque can be maintained for a prolonged time period thereby publicly honoring the donor for a long-term period. As noted in the background, conventional fundraising schemes such as live fundraising via television or radio do not have convenient means to publicly honor and acknowledge the donor for a prolonged period. For example, a moderator may be required to read the names of the donors periodically as additional donations are made. The purpose of the virtual plaque is to publicly honor the donors for a prolonged time period. This encourages a viewer of the virtual plaque to make a donation so that the viewer can get his or her own virtual plaque by making the donation.

The web page 204 may also contain various other inducements to donate as well as information about how to donate. For example, the web page may include information regarding available gifts that are given to donors for various levels of donation.

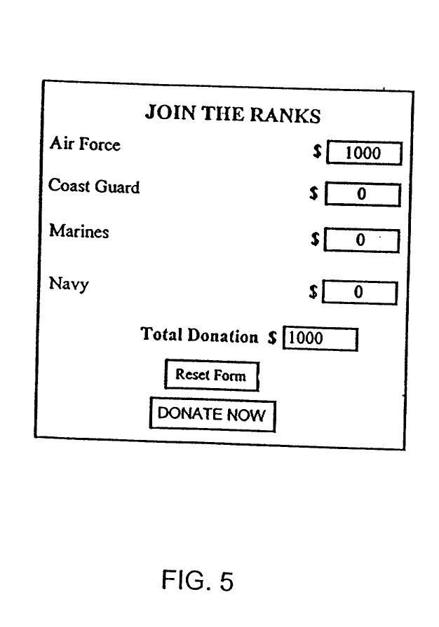

In one embodiment of the invention, the web page 208 preferably contains a hyperlink to a web page 212, wherein the viewer sees a display giving various donation options. An example of the web page 212 is shown in FIG. 5. FIG. 5 shows various donation options, including options to donate to one or more branches of the Armed Forces and the amount of the donation.

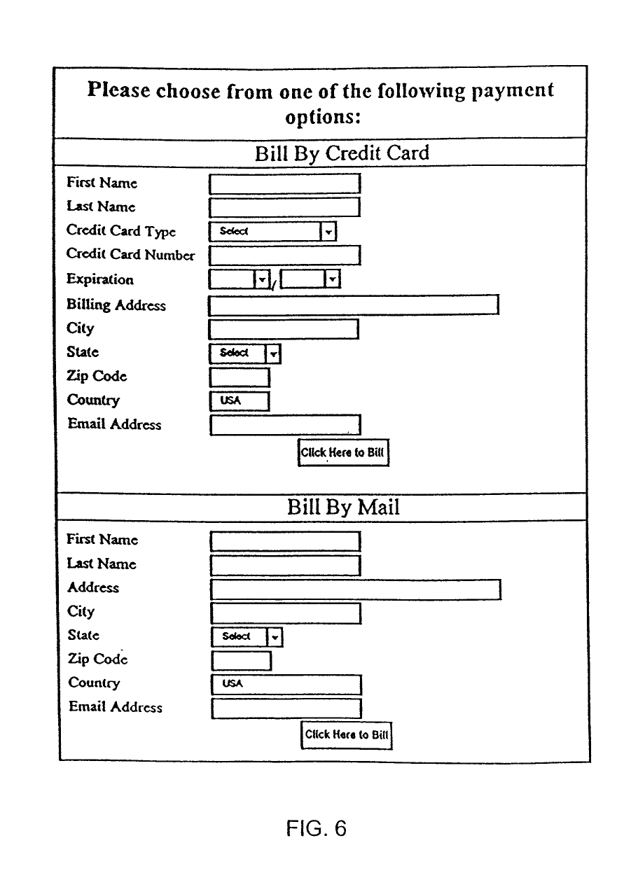

The web page 212 also contains a hyperlink to a web page 216, which presents the viewer with various payment options for paying a pledge. An example of the web page 216 is shown in FIG. 6. In the example of FIG. 6, the options include payment by credit card or payment to be made after being billed by regular mail or by e-mail.

In one embodiment, the payment options include a lump-sum payment option and an installment payment option. In the lump-sum payment option, the donor pays the entire amount due in one lump sum while, in the installment payment option, the donor pays the amount due in several installments, e.g., monthly. Alternatively, a donor may pledge to make a donation in installments for an extended period of time or until cancelled by the donor. In the installment payment option, each installment amount can be automatically charged to the donor's credit card or bank account.

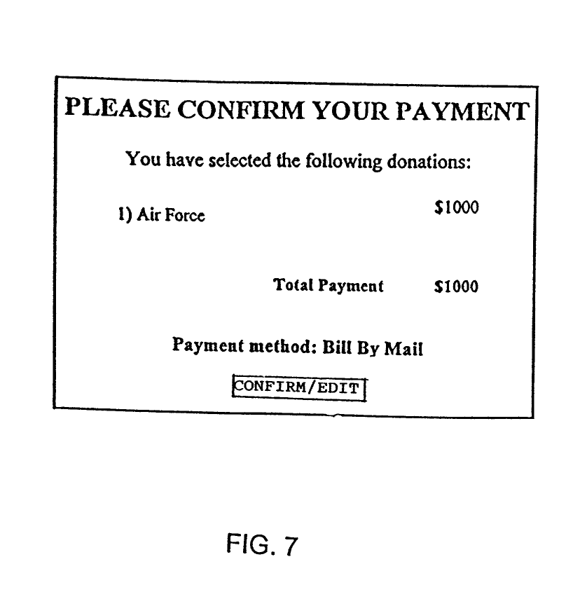

In one embodiment, after the donor makes a payment, the donor is presented with confirmation page 220. An example of confirmation page 220 is shown in FIG. 7. The donor may choose to confirm the payment option of the contribution or to edit the donation information and the selection of billing method. Clicking on the “CONFIRM” button takes the donor to web page 224 which may comprise a thank you note containing all the donation-related information of the present transaction that can be saved or printed for tax reporting and other reasons. This page may also contain questions to obtain demographic information that may be of use later on in additional solicitations. Clicking on the “EDIT” button takes the donor back to the web page 212, wherein the donor can edit the donation information and billing method.

In one embodiment of the invention, the web page 224 contains a link back to web page 208 (i.e., the virtual plaque), which by now has been updated to include the present donor's name and/or other donation-related information. The updated plaque publicly acknowledges and honors the new donor for the contribution to the charitable cause. Thus, the interactive feature of the present invention allows a donor to make a donation and view an updated plaque. Also, in one embodiment of the invention, a donor can edit the updated plaque and select particular words or language. This can be done at the time of the donation or at a later time.

In one embodiment of the invention, the updated plaque or a link thereto can be conveniently e-mailed to others. For example, the web page 208 may include an e-mail address field wherein e-mail addresses of intended recipients can be entered. This provides an efficient means for the donor to forward the updated plaque to his friends, family and others so that they may learn about the contribution made by the donor and also learn about the charitable cause. In one embodiment, the web page 208 includes a hyperlink that directs a user back to the web page 204, i.e., the promotional web page. This way, the recipients may also make a donation by following the process described herein. Once the recipients contribute to the charitable cause and have their names included in updated plaques, they can also e-mail the plaques to others.

Thus, the present invention provides a convenient way for a donor to spread the message regarding the charitable cause and the contribution made by sending the updated plaque to friends and family. Furthermore, the present invention provides for improved payment behavior by pledgors. The fact that the updated plaque remains on-line induces the pledgor to honor the pledge thereby improving the payment behavior. Also, if a pledgor e-mails the updated plaque to others, there is an increased likelihood that pledgor will pay the pledge since the word of the pledge has already been publicized to others. In one embodiment, the virtual plague honoring a donor is not created until the donor pays the pledge and the donation amount is actually received by the organization.

Furthermore, the present invention increases the likelihood of contribution from additional donors by proliferating the virtual plaques that honor and acknowledge charitable contributions.

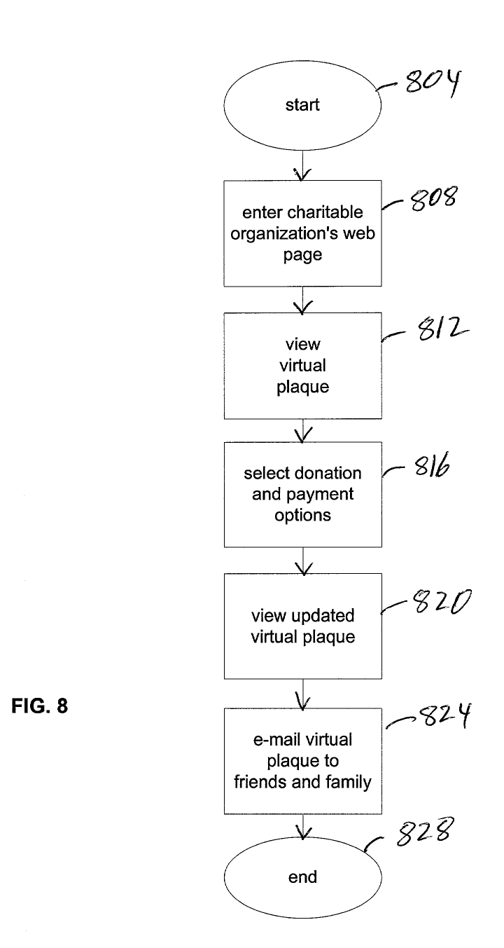

FIG. 8 is a flow diagram illustrating an exemplary method for implementing an interactive fundraising event over the Internet. The method begins at step 804 and proceeds to step 808 where a potential donor enters a charitable organization's website that includes promotional information about the organization, including the charitable cause. The web page 804 is accessible on the Internet and published in an on-line format.

The method then proceeds to step 812 where the potential donor sees one or more virtual plaques honoring those who have already pledged or given to the cause. Next, the donor selects the appropriate donation and payment options as mentioned in step 816. The method then proceeds to step 820 where the donor views an updated virtual plaque or a new virtual plaque that includes the new donor's name and/or other donation-related information. The new virtual plaque publicly acknowledges and honors the donor for the contribution to the charitable cause.

The method proceeds next to step 824 where the donor forwards the updated plaque to friends, families and others so that they may learn about the contribution made by the donor and also learn about the charitable cause. The method ends at step 828.

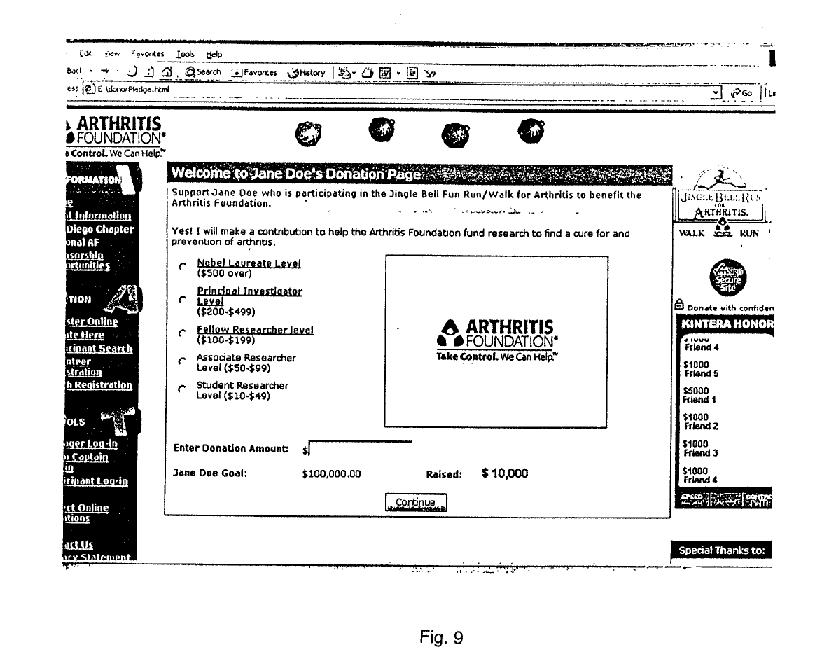

In one embodiment, a donor can obtain a personalized donation page on the web after making a donation. FIG. 9 illustrates a personalized donation page. In one embodiment, the personalized donation page or a link to the page can be e-mailed or otherwise forwarded to others so that others may learn about the charity and donate on this page. In one embodiment, there is a link in the e-mail to the personalized donation page. When a donation is received from other donors on the personalized donation page, the additional donors names can be included in a virtual plaque on the personalized donation page as illustrated in FIG. 9.

As illustrated in FIG. 9, a donation page seeks support for the Arthritis Foundation. The donation page allows others to make a donation in support of the Arthritis Foundation as well as show support for the original donor. In FIG. 9, Jane Doe is the original donor who can e-mail the personalized donation page or the link thereof to her friends and family. As a show of support for Jane Doe, her friends and family may make donations in support of the charitable cause as well. Jane Doe's friends and family can obtain a virtual plaque on Jane Doe's personalized donation page as illustrated in FIG. 9. The virtual plaque may be a scrolling, dynamic type or a conventional static type.

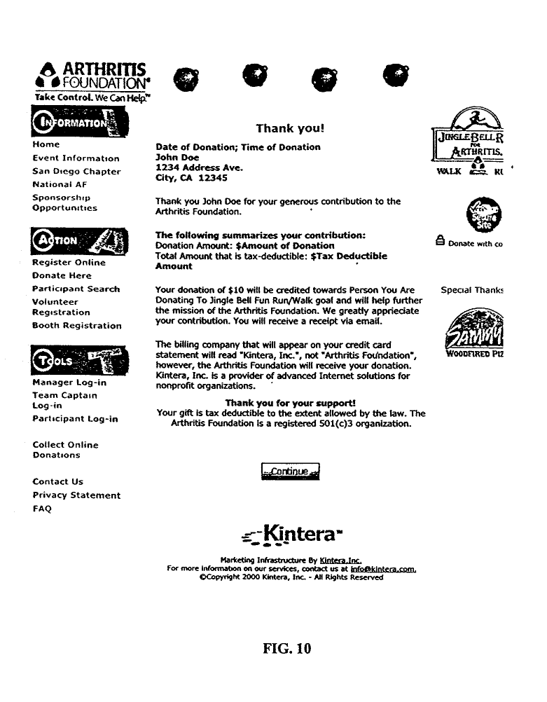

In one embodiment, an e-mail is automatically created and sent to a donor thanking the donor for a contribution. FIG. 10 illustrates an exemplary e-mail thanking the donor for a donation. This e-mail can include information regarding tax consequences of the donation and can be conveniently used by the donor for tax reporting purposes. This e-mail may also include other information, such as tax related deductions and value of a prize.

In one embodiment, a report is automatically generated and e-mailed to the organization that is conducting the fundraising campaign. The report includes information, such as total amount of donations received, the number of donors, the average amount of donations received, etc. The report may be constantly updated to reflect new donations.

In one embodiment, the program code for carrying out the steps in accordance with the present invention can be stored in a storage medium and made available for sale as a software program or a computer program product. For example, the program code can be stored in a compact disk (CD), a magnetic tape, or any other type of storage medium. A manufacturer can make the software program available for sale so that individuals and business entities may purchase or otherwise obtain the software program to set up an automated, on-line donation processing system.

Thus, it is apparent that there has been provided, in accordance with the present invention, a system and method for interactive fundraising over a wide-area computer network. Although the preferred embodiments have been described, it should be understood that various changes, substitutions, and alterations can be made herein without departing from the scope of the present invention. For example, although the present invention has been described and illustrated primarily in relation to Internet applications, it should be understood that the present invention is in no way limited to only the Internet and may be implemented on other networks also. Furthermore, it should be noted that the present invention may be implemented using virtually any computer system and virtually any available programming language. Other examples of changes, substitutions, and alterations are readily ascertainable by one skilled in the art and could be made without departing from the spirit and scope of the present invention as defined by the following claims.

What is claimed is:

1. A method for on-line, interactive fundraising for an organization over a wide-area network, comprising the steps of:
hosting the organization's website including a plurality of hyperlinked web pages;
displaying one or more web pages with virtual plaque honoring donors;
providing one or more donation and payment web pages; and
updating virtual plaques on the web pages with virtual plaque when a donation is made.

2. The method as recited in claim 1, further comprising the step of e-mailing the updated virtual plaques to potential donors, thereby spreading the message regarding the cause and increasing the likelihood of contribution from additional donors.

3. The method as recited in claim 1, wherein the virtual plaque is a static virtual plaque.

4. The method as recited in claim 1, wherein the virtual plaque is a scrolling virtual plaque.

5. The method as recited in claim 1, wherein the wide-area network is the Internet.

6. The method as recited in claim 1, further comprising the step of editing and modifying the virtual plaque.

7. The method as recited in claim 1, further comprising the step of broadcasting the virtual plaque on television.

8. The method as recited in claim 1, further comprising the step of creating a personalized donation page for a donor.

9. The method as recited in claim 1, further comprising the step of e-mailing a report to a donor.

10. The method as recited in claim 1, further comprising the step of providing promotional information about the organization and the fundraising cause on the website.

11. The method as recited in claim 1, further comprising the step of including information about the donor and the contribution on the virtual plaque.

12. The method as recited in claim 1, wherein the payment option includes payment by credit card.

13. The method as recited in claim 1, wherein the payment option includes payment by mail.

14. The method as recited in claim 1, wherein the payment option includes payment in two or more installments.

15. The method as recited in claim 1, wherein the organization is a charitable organization.

16. The method as recited in claim 1, wherein the organization is a political action committee.

17. The method as recited in claim 1, wherein the organization is a political organization.

18. The method as recited in claim 1, wherein the virtual plaque is created on a web page containing an image of a book.

19. The method as recited in claim 1, wherein the virtual plaque is created on a web page containing an image of an art work.

20. An on-line, interactive fundraising system over a wide-area network for an organization, comprising:
a website dedicated to the organization, including a plurality of hyperlinked web pages;
one or more web pages with virtual plaque honoring donors;
one or more donation and payment web pages; and
means for updating the virtual plaque on the web pages with virtual plaque when a donation is made.

21. The system as recited in claim 20, further comprising means for e-mailing the updated virtual plaques to potential donors,
wherein the system allows a donor to spread the message regarding the fundraising by forwarding the virtual plaques to other potential donors and thereby increasing the likelihood of contribution from additional donors.

22. The system as recited in claim 20, wherein the wide-area network is the Internet.

23. The system as recited in claim 20, further including information about the organization and the cause on the website.

24. The system as recited in claim 20, further including information about the donor and the donor's contribution on the virtual plaque.

25. The system as recited in claim 20, further comprising means for receiving payment by a credit card.

26. The system as recited in claim 20, further comprising means for receiving payment in two or more installments.

27. The system as recited in claim 20, wherein the organization is a charitable organization.

28. The system as recited in claim 20, wherein the recipient of the virtual plaques may make donations, receive new virtual plaques, and re-forward the new virtual plaques to others.

29. The system as recited in claim 20, further comprising means for editing and thereby modifying the virtual plaque.

30. The system as recited in claim 20, wherein the virtual plaque is a static virtual plaque.

31. The system as recited in claim 20, wherein the virtual plaque is a dynamic, scrolling virtual plaque.

32. The system as recited in claim 20, further comprising a personalized donation page for a donor.

33. The system as recited in claim 32, wherein the virtual plaque is located on the personalized donation page.

34. The system as recited in claim 20, further comprising means for broadcasting the virtual plaque on television.

35. The system as recited in claim 20, wherein the organization is a political action committee (PAC).

36. The system as recited in claim 20, wherein the organization is a political organization.

37. The system as recited in claim 20, wherein the virtual plaque is created on a web page containing an image of a book.

38. The system as recited in claim 20, wherein the virtual plaque is created on a web page containing an image of an art work.

39. An automated, on-line donor recognition system, comprising:
a website dedicated to an organization, including a plurality of hyperlinked web pages;
one or more personalized donation pages for donors;
one or more web pages with virtual plaque honoring the donors; and
means for modifying the virtual plaques when a donation is made.

40. The system as recited in claim 39, further comprising means for editing the virtual plaques.

41. The system as recited in claim 39, further comprising means for creating email messages acknowledging a donor.

42. A computer program product including a program code embodied in a storage medium for carrying out the method steps for on-line, interactive fundraising for over a wide-area network, comprising the steps of:
hosting an organization's website including a plurality of hyperlinked web pages;
displaying one or more web pages with virtual plaque honoring donors;
providing one or more donation and payment web pages; and
modifying the virtual plaques when a donation is made.

43. A method for hosting web-based, interactive fundraising system for an organization over a wide-area network, comprising the steps of:
hosting the organization's website including a plurality of hyperlinked web pages;
displaying one or more web pages with virtual plaque honoring donors;
providing one or more donation and payment web pages; and
updating virtual plaques on the web pages with virtual plaque when a donation is made.
